(19) United States
(12) Patent Application Publication
(10) Pub. No.: US 2007/0083796 A1
(43) Pub. Date: Apr. 12, 2007

(54) Methods and systems for forecasting status of clustered computing systems

(76) Inventors: Jonathan Patrizio, San Francisco, CA (US); Farid Faez, Sunnyvale, CA (US); Venu Pola, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/248,468

(22) Filed: Oct. 11, 2005

(51) Int. Cl. G06F 11/00

(52) U.S. Cl. 714/41

(57) ABSTRACT

The invention provides methods of forecasting functionality for clustered computing configurations that may be deployed across computer network systems and environments that may function in conjunction with a wide range of hardware and software configurations. An exemplary method of forecasting a forecast status of a clustered computing system is presented including: creating a current status model of the clustered computing system based on a start data set; applying an event input set to the current status model; and creating a forecast status based on the applying the event input set to the current status model. In some embodiments, the current status model may be represented by: a configured operational status, a current operational status, and a projected operational status of the clustered computing system.

### CROSS REFERENCE TO RELATED APPLICATIONS

The present invention is related to the following application, all of which is incorporated herein by reference:

Commonly assigned application entitled “SYSTEMS AND METHODS FOR PLACING AND DRAGGING PROGRAMMATIC PACKAGES IN CLUSTERED COMPUTING SYSTEMS,” filed on even date herewith by the same inventors herein (Attorney Docket Number: 200407298-1).

### BACKGROUND

With the evolution and proliferation of computer systems and computer networks, modern users have come to rely on technical systems that were once thought of as luxuries. Email, chat, online sales, data access, and other related data services have become part of the daily routine of millions of users. As such, reliable data service with 24-hour access has become expected and relied upon by Internet users across the globe.

As a result of the tremendous pressure placed on companies to deliver reliable data services, many strategies have been implemented to assure continuous access such as data mirror sites, multiple redundant systems, clustered computing systems, and the like. In particular, clustered computing systems are being utilized by many data service providers for critical services. Clustered computing systems may be created by connecting two or more computers together in such a way that they behave like a single computer. Clustering may be used for parallel processing, load balancing, and fault tolerance. Clustering is a popular strategy for implementing parallel processing applications because it enables companies to leverage an investment already made in PCs and workstations. In addition, it's relatively easy to add new CPUs simply by adding a new PC to the network.

In the past, some companies utilized only a handful of computers executing relatively simple software. These early systems were relatively simple to manage especially when confronting and isolating problems. In the present networked computing environments and particularly in clustered systems, however, information systems can contain hundreds of interdependent servers and applications. Failure in one of these components can potentially cause a cascade of failures that could bring down one or more servers leaving providers susceptible to catastrophic data losses. One category of problem that is particularly troublesome for computing system administrators is a single point failure. A single point failure is a failure occurring at one point in a system that results in catastrophic failure of the entire system. Avoiding single point failures (along with other types of failures) by testing various configurations of clustered computing systems may, therefore, be desirable.

One problem encountered in maintaining clustered computing systems to avoid failures, is the dizzying array of interactions presented by modern clustered computing systems. For example, a two node cluster having at least four operational conditions (i.e. hardware/software constraints and requirements) may present as many as 8000 different possible configurations to a user. Testing and qualifying each of the eight thousand plus configurations may quickly become unfeasible due to time and resource constraints. The problem is exacerbated when those configurations are tested against an array of failure events.

In light of the foregoing, methods and systems for forecasting status of clustered computing systems are presented herein.

### SUMMARY

The invention provides methods of forecasting functionality for clustered computing configurations that may be deployed across computer network systems and environments that may function in conjunction with a wide range of hardware and software configurations.

An exemplary method of forecasting a forecast status of a clustered computing system is presented including: creating a current status model of the clustered computing system based on a start data set; applying an event input set to the current status model; and creating a forecast status based on the applying the event input set to the current status model. In some embodiments, the current status model may be represented by: a configured operational status, a current operational status, and a projected operational status of the clustered computing system. In some embodiments, the above applying an event input set and creating a forecast status may be repeated such that a plurality of event input sets may be tested. In some embodiments, the start data set includes: an application package information data set; a node information data set; a dependency information data set; and a priority information data set. In some embodiments, the dependency information data set includes: a same node exclusion dependency, an all node exclusion dependency, a same node up dependency, an any node up dependency, and a different node up dependency. In some embodiments, the event input set includes: a hardware failure, a hardware addition, a node failure, a node addition, an application package failure, a application package addition, a network failure, a package services failure, a shutdown, and a reboot.

### BRIEF DESCRIPTION OF THE DRAWINGS

Embodiments of the invention may best be understood by reference to the following description taken in conjunction with the accompanying drawings in which:

FIG. 1 is as simplified graphical representation of example clustered computing systems for providing services over an internet;

FIG. 2 is a simplified graphical representation of a three node clustered computing system;

FIG. 3 is an example graphical user interface of a clustered computing system in accordance with an embodiment of the present invention;

FIG. 4 is a graphical representation of a package dependency graph in accordance with an embodiment of the present invention;

FIG. 5 is a simplified functional block diagram of an embodiment of the present invention; and

FIG. 6 is a flow chart of an embodiment of the present invention.

### DETAILED DESCRIPTION

The present invention will now be described in detail with reference to a few embodiments herein as illustrated in the accompanying drawings. In the following description, numerous specific details are set forth in order to provide a thorough understanding of the present invention. It will be apparent, however, to one skilled in the art that the present invention may be practiced without some or all of these specific details. In other instances, well known process steps and/or structures have not been described in detail in order to not unnecessarily obscure the present invention.

In accordance with embodiments of the present invention, there are provided methods and systems for forecasting operational status of clustered computing systems. Embodiments of the present invention allow a user to test configurations and event scenarios in clustered computing systems.

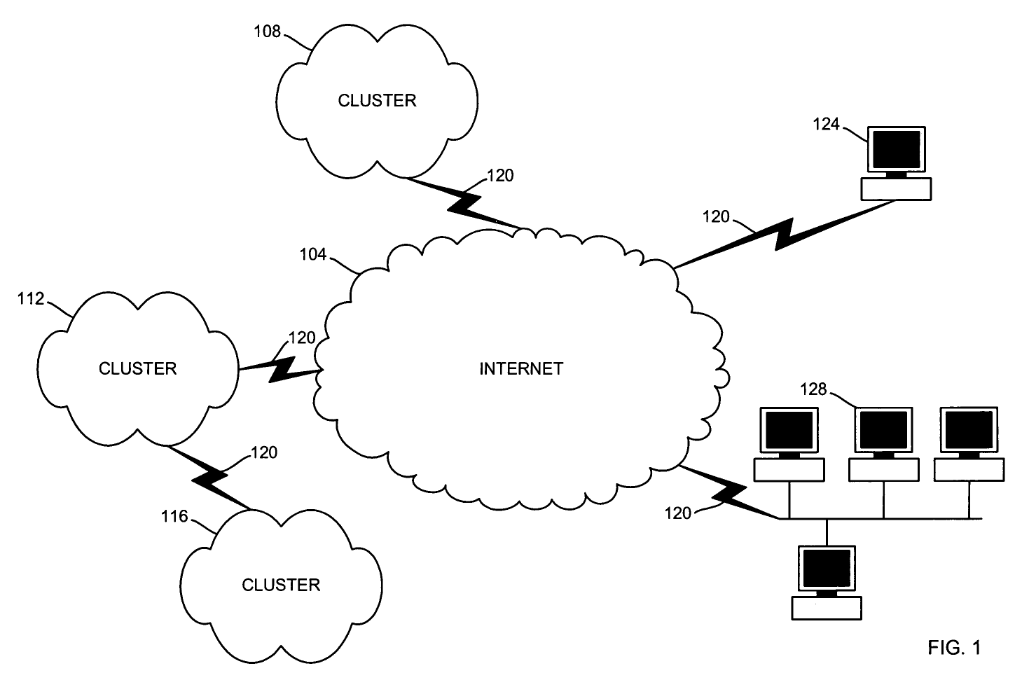

Referring to FIG. 1, FIG. 1 is as simplified graphical representation of example clustered computing systems for providing services over an internet. In particular, FIG. 1 presents a graphical representation for conceptualizing an example environment in which embodiments of the present invention may be practiced. As illustrated, a cluster 108 or a system of clusters 112, 116 may connected with a local internet or with the Internet represented by internet cloud 104 over data communication links 120. Clusters 108-116 may provide any number of services which may be configured as highly available. Highly available clusters are generally configured to provide reliable and robust services. In a highly available cluster, when a component fails, a back-up component may be utilized to ensure and provide uninterrupted service. In many instances, multiple redundant systems may be utilized. For example, within cluster 108, several nodes, or computing systems, may be configured to provide email services. Conceptually, a cluster may act as a single processing unit. That is, a cluster appears to a user to be a sole computing system providing email. Operationally, however, cluster 108 may have several nodes sharing processing loads or mirroring active nodes. When a cluster node fails, a cluster may be configured to failover to another cluster node in order to provide continuous services. As another example, clusters 112 and 116 may function cooperatively to provide a service or number of services. Each cluster 112 and 116 may provide the same or different services, or may be mirrors of each other. In an example of a mirror configuration where cluster 116 mirrors cluster 112: if cluster 112 were to fail, mirror cluster 116 would immediately take over services of failed cluster 112. Clusters may be configured in any of a number of different configurations. The examples provided herein are for illustrative purposes only and should not be construed as limiting.

Further, internet cloud 104 is merely a simplified illustration representing any number of network resources configured to maintain a linkage between users and clustered computing systems that provide services for users. Internet cloud 104 may represent, for example, a LAN, a WAN, or the Internet without limitation. As noted above, data communication links 120 may provide interconnection between clusters, between clusters and internets, and between internets and clients. That is, data communication links 120 may connect internet cloud 104 with a single user 124 or network of users 128 without limitation. One skilled in the art can appreciate that data communication links 120 may be implemented over any suitable protocol.

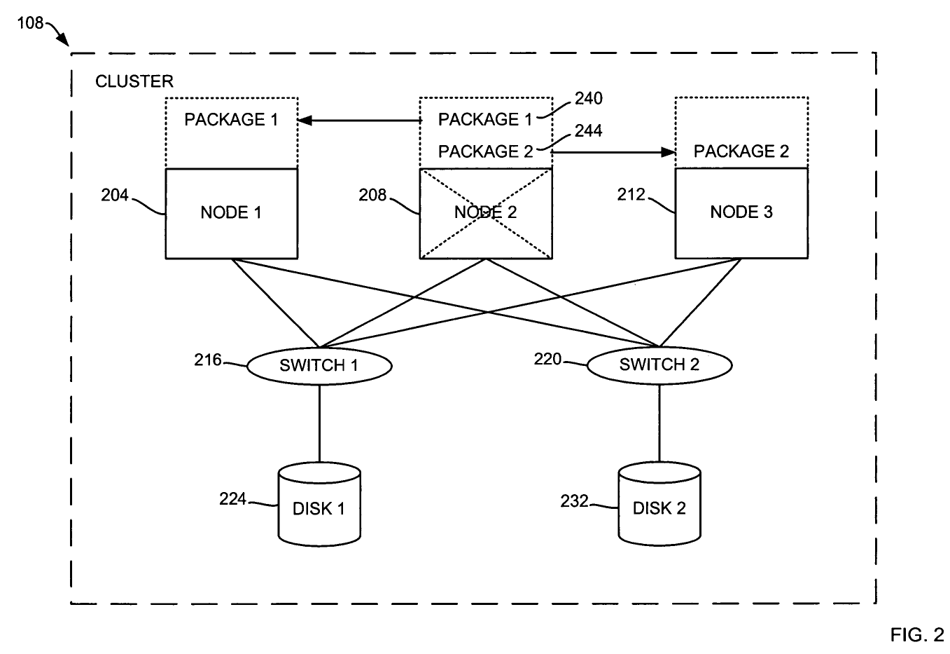

FIG. 2 is a simplified graphical representation of a three-node clustered computing system. In particular, FIG. 2 is a representative illustration of cluster 108 of FIG. 1. Organized as cluster 108 are nodes 204-212. All nodes may be electronically coupled via switches 216 and 220. Switches 216 and 220 provide connectivity between nodes and resources and provide various connection configurations options in accordance with user preferences and configuration limitations. Disks 224 and 232 are connected with switches 216 and 220. Disks 224 and 232 may provide data and data storage for nodes 204-212. Disks are shown here for illustrative purposes only. Other peripheral equipment may be connected with nodes 204-212 without limitation. In some examples, clusters typically require redundant data and heartbeat networks between nodes and may contain as many as three or more redundant network connections between nodes (not shown). In still other examples, cluster nodes may have redundant network interface cards (NIC) (not shown).

In an initial operating state, node 208 may be running application packages (hereinafter “package”) 240-244. A package may be a service such as email for example. Packages may also represent one or more applications being run in conjunction with a provided service. If, in one example, node 208 should fail as indicated by the dotted “X,” package 240 may be configured to migrate to node 204 while package 244 may be configured to migrate to node 212. Migration of packages 240 and 244 to nodes 204 and 212 respectively demonstrates a method by which clusters operate to provide highly available services. And while the illustrated cluster has only three nodes, more nodes may be configured in a cluster. Further, while only two packages are illustrated, many more packages may be configured and used in a cluster. In the illustrated example, a simple failover algorithm may be employed to accomplish migration. For example, a simple algorithm may take the form:
If node 2 fails, then package 1 migrates to node 1 and package 2 migrates to node 3 (1)

The above illustrative algorithm demonstrates an example relationship between clusters, nodes, and packages. Relationships may be much more complex and may include package dependency. Briefly, package dependency describes a set of conditions which must be fulfilled in order for a given package to operate properly. For example, a package dependency for a given package A might describe a configuration requiring that when another package (package B) is running, package A must wait until package B has ended. Package dependencies may be hardware, software, or environmentally dependent without limitation.

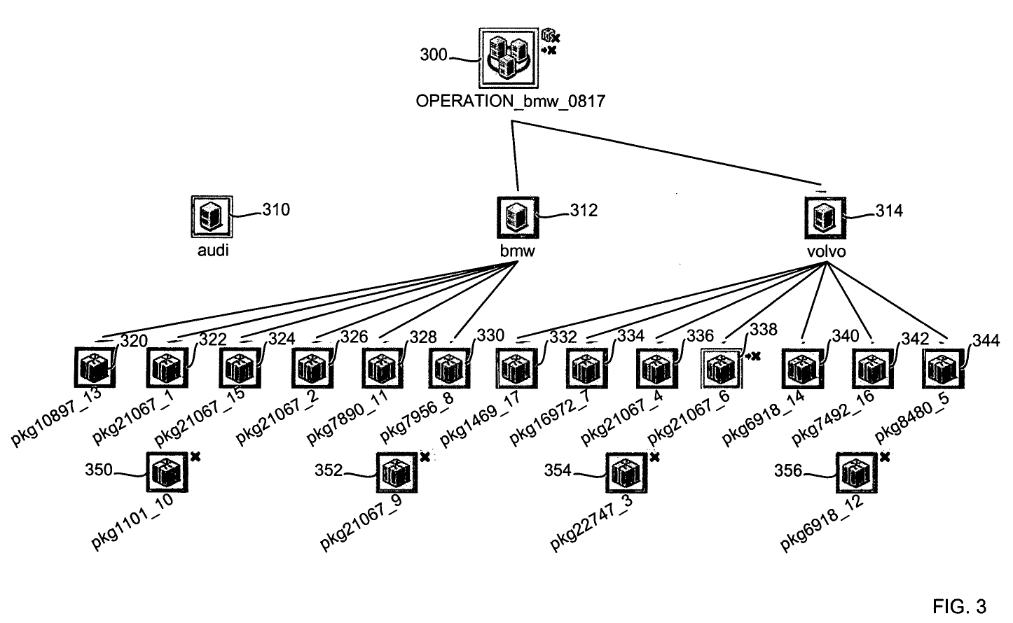

FIG. 3 is an example graphical user interface (GUI) of a clustered computing system in accordance with an embodiment of the present invention. In particular, FIG. 3 illustrates an example operational status of a cluster. The illustrated operational status may represent either a configured operational status, a current operational status, or a projected operational status of a clustered computing system. In general, cluster 300 includes several nodes 310-314, several running packages 320-344, and several halted packages 350-356. Operationally, cluster 300 may provide any number of services. As illustrated node 310 is down and halted. Nodes 312 and 314 are up and running. That is, the nodes are fully operational. All three nodes may have associated resources not shown in this embodiment. Further, at this level, no indications of possible connections (e.g. dotted lines) are represented although those representations may be made in other embodiments.

Nodes 312 and 314, as illustrated, include packages 320-330, and 332-344 respectively. Further, package 338, as illustrated, is disabled in an auto-run mode. Thus, a graphical icon may (e.g. “x”) be used to illustrate a particular conditions of a package. Packages may be generally described as an application or service. Packages may further be independent or dependent. Independent packages may run on a node and require no other packages or conflict with no other packages. Dependent packages have some configured package dependency which may relate to other packages, nodes, cluster resources, or clusters. The order in which packages are illustrated herein is not inherently limiting. Any desired order may be illustrated without departing from the present invention.

Also illustrated are halted packages 350-356. Halted packages are packages which, for whatever reason, are no longer running in the cluster. Halted packages may result, for example, from a software failure, a hardware failure, a combination of hardware or software failures, a time-out, a user selection, and others without limitation. Thus, the GUI as illustrated in FIG. 3 is a representation of a current status of a cluster of interest. One skilled in the art can appreciate that a GUI is only one type of representation possible.

Command line text may also return a status of a clustered computer system. It may be appreciated that command line text may be implemented in any suitable convention that is well known in the art. The command line text illustrated below is for illustrative purposes only and should not be construed as limiting in any way. Thus, in one example, a command call of the type:
bmw:/>cmviewcl (2)

may return a table of information as shown below:

TABLE 1

| CLUSTER | STATUS |
|---|---|
| OPERATION_bmw_0817 | up |

| NODE | STATUS | STATE |
|---|---|---|
| audi | down | halted |
| bmw | up | running |

| PACKAGE | STATUS | STATE | AUTO_RUN | NODE |
|---|---|---|---|---|
| pkg7956_8 | up | running | enabled | bmw |
| pkg7890_11 | up | running | enabled | bmw |
| pkg21067_1 | up | running | enabled | bmw |
| pkg21067_2 | up | running | enabled | bmw |
| pkg21067_15 | up | running | enabled | bmw |
| pkg10897_13 | up | running | enabled | bmw |

| NODE | STATUS | STATE |
|---|---|---|
| volvo | up | running |

| PACKAGE | STATUS | STATE | AUTO_RUN | NODE |
|---|---|---|---|---|
| pkg16972_7 | up | running | enabled | volvo |
| pkg21067_4 | up | running | enabled | volvo |
| pkg21067_6 | up | running | enabled | volvo |
| pkg1469_17 | up | running | enabled | volvo |
| pkg6918_14 | up | running | enabled | volvo |
| pkg7492_16 | up | running | enabled | volvo |
| pkge8480_5 | up | running | enabled | volvo |

UNOWNED_PACKAGES

| PACKAGE | STATUS | STATE | AUTO_RUN | NODE |
|---|---|---|---|---|
| pkg22747_3 | down | halted | disabled | unowned |
| pkg21067_9 | down | halted | disabled | unowned |
| pkg1101_10 | down | halted | disabled | unowned |
| pkg6918_12 | down | halted | disabled | unowned |

The above Table 1 corresponds to FIG. 3. As such, Table 1 may be compared directly to FIG. 3. Other parameters of interest may also be returned in command line text and are contemplated within the scope of this invention.

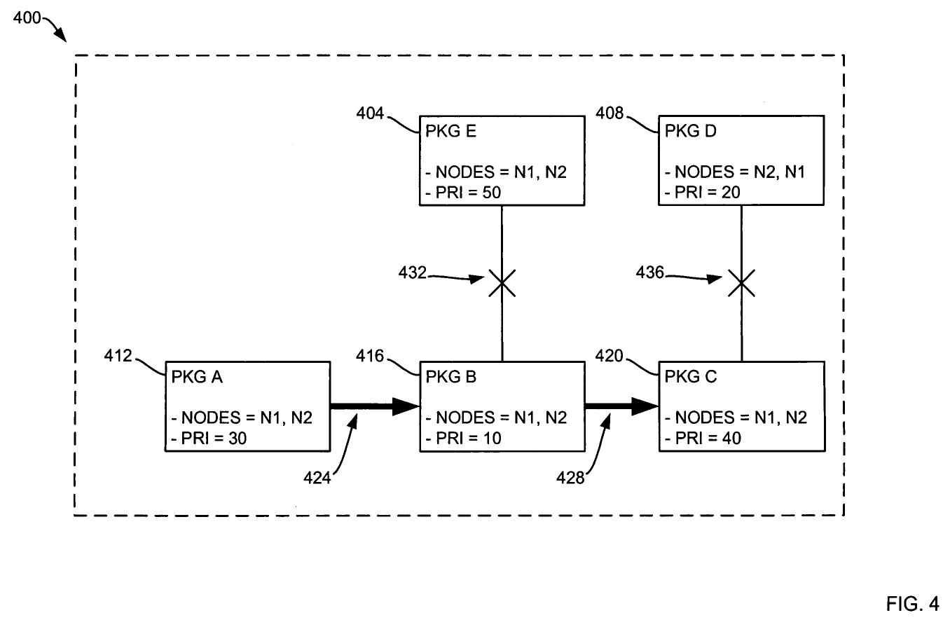

Referring to FIG. 4, FIG. 4 is a graphical representation of a package dependency graph 400 in accordance with an embodiment of the present invention. In particular, FIG. 4 illustrates examples of the types of package properties that might be encountered in a node. Dependency graph 400 illustrates relationships between a variety of services, or packages as functional parts of a clustered computing system. In some embodiments, a node may have as many as approximately 150 packages running. Each package may have any number of properties that describe the package's relationship in a cluster. Thus, for example, package E 404 may include: a location component, a dependency component, and a priority component. A location component describes where a particular package may be run. In this instance, the location component of package E 404 is node 1 and node 2, which means that package E 404 may be run on either node 1, node 2, or, in some instances, both. Locations may be selected based on user criteria and may correspond to hardware or software constraints. Further, locations are not restricted to a single node as clusters may function in a coordinated fashion using one or many nodes to provide a particular service.

Package E 404 may also include a dependency component. One dependency component is illustrated by connection 432. Connection 432 is an example of a mutual exclusion dependency with respect to package B 416 to indicate that package E 404 cannot run concurrently with package B 416. Mutual exclusion dependency may be configured in any number of different manners. In one embodiment, package E 404 may be configured not to run simultaneously on the same node as package B 416. In other embodiments, package E 404 may be configured to not run simultaneously in the same cluster as package B 416.

Other dependency components may be configured as well. Connections 424 and 428 illustrate example same node dependencies. A same node dependency relationship describes a configuration where a given package requires another package to be running on a same node in order for the given package to run. As can be appreciated, dependencies may be temporally restricted. For example, as shown, package A 412 depends on package B 416 which in turn depends on package C 420. That is, package C 420 must be up and running before package B 416 may be run. In turn, package B 416 must be up and running before package A 412 may be run. Package dependencies may be necessary where a single package is insufficient to provide a desired service. For example, a finance program may require several database programs in order to provide a full suite of functionality. Thus, the finance program may be configured to depend on those database programs such that the database programs must be up and running before the finance program is started. Other example dependencies include, but are not limited to: an all node exclusion dependency, a same node up dependency, an any node up dependency, and a different node up dependency. These and other embodiments are contemplated in the present invention.

Still another condition component is a priority. In general, package priority corresponds to a user designated assignment of programmatic importance. Priority describes ascendancy with respect to packages. For example, a user may configure a set of packages on a cluster to provide desired services that might include: a database package, a mail server package, and a query package. In an ideal setting, all packages would be up and running thus providing all desired services. However, when a node failure occurs, for example, then some or all of the service providing packages may not be able to run on remaining nodes. In those instances, it may be useful to assign a priority to each package so that a system may preserve the most critical services. In this example, a high priority may be assigned to the database package while a low priority may be assigned to the query package. Thus, in the event of a node failure, the system will attempt to keep the database package running over the query package. Package priority is discussed in further detail in related application entitled, “SYSTEMS AND METHODS FOR PLACING AND DRAGGING PROGRAMMATIC PACKAGES IN CLUSTERED COMPUTING SYSTEMS,” which is incorporated herein by reference.

As can be appreciated, a dependency graph as illustrated in FIG. 4 shows only a few of many possible package properties. As the number of packages and package properties increase, then number of connections and relationships increase rapidly. For example, consider an example of two packages having two properties that are temporally restricted may have as many as 32 possible permutations. With three properties, the number of possible permutations rises to 510. With four properties, the number of possible permutations rises to over 8000. Thus, an exponential-like rise in the number of permutations may be experienced. One skilled in the art will recognize that a vast number of permutations may be illustrated using a dependency graph. Further, a dependency graph illustrates the complexity with which a cluster may be configured. Package properties may be stored in any manner generally known in the art.

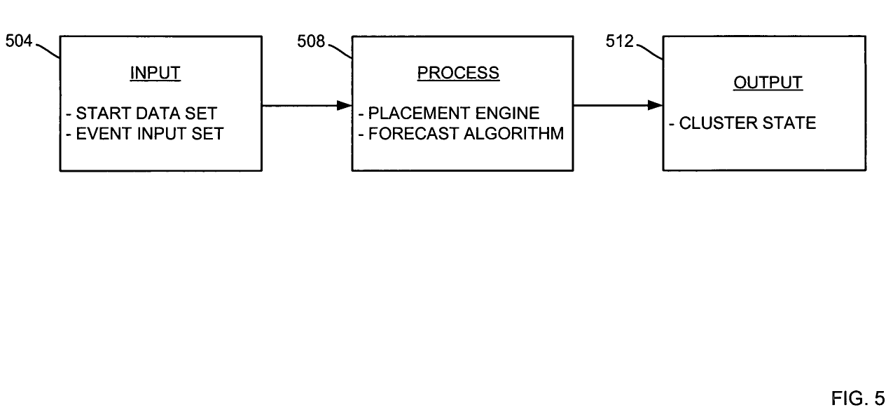

FIG. 5 is a simplified functional component diagram of an embodiment of the present invention. An input component 504, a process component 508, and an output component 512 are illustrated. Input component 504 includes a start data set or cluster configuration data set, and an event input set. A start data set includes, for example, data representing a current status model. Current status models include: a configured operational status, a current operational status, or a projected operational status. A configured operational status may represent a configuration of a clustered computing system as it was originally contemplated or implemented. A current operational status may represent a configuration that is in current use. Current operational status may be found either by inspection or by query. A projected operational status may represent a hypothetical configuration of interest to a user.

Input component 504 also includes an event input set. An event input set includes, for example, any number of actual, expected, or hypothetical events which will be applied to a configuration defined by a start data set. In one example, a node failure may define an event input set. In another example, a package failure may define an event input set. In still other examples, a test configuration may define an event input set. As can be appreciated, any number of examples may be utilized to define an event input set.

Process component 508 includes a placement engine, and a forecast algorithm. Generally, placement is a process by which a package is assigned to a node. Placement on an assigned node takes into account location (i.e. node) and conditions (i.e. dependency and priority) for a given programmatic package so that user preferences may be preserved. Placement is discussed in further detail in related application entitled, “SYSTEMS AND METHODS FOR PLACING AND DRAGGING PROGRAMMATIC PACKAGES IN CLUSTERED COMPUTING SYSTEMS,” which is incorporated herein by reference.

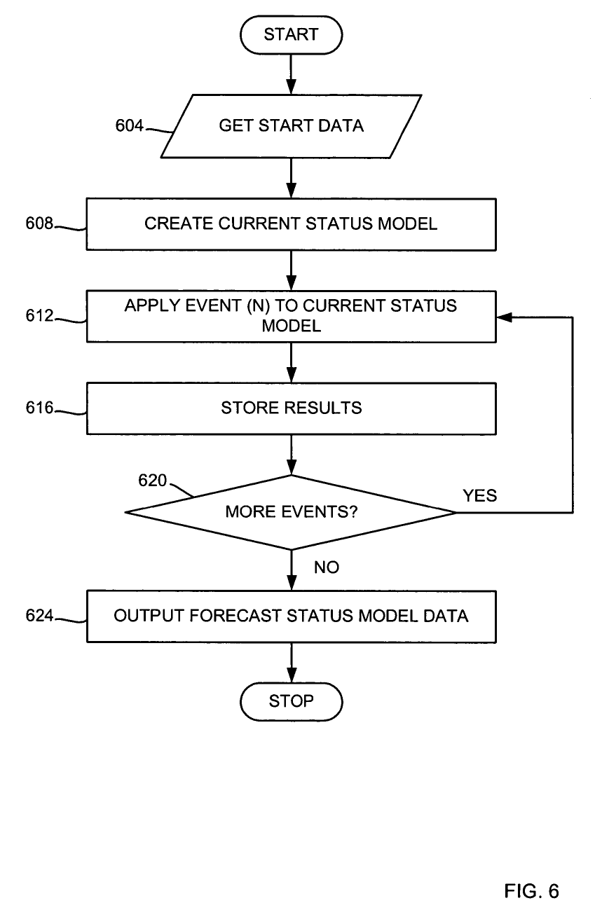

A forecast algorithm may be used to generate an operational status based on a start data set and an event input set. Forecast algorithms will be discussed in further detail below for FIG. 6. After data is collected and processed, a cluster state, which describes the state of a cluster after a process is complete, may be generated an output component 512.

Referring to FIG. 6, FIG. 6 is a flow chart of an embodiment of the present invention. In particular, FIG. 6 further illustrates the simplified functional block diagram illustrated in FIG. 5. At a first step 604, a start data set or a cluster configuration data set may be received. As noted above, a start data set includes, for example, an application package information data set; a node information data set; a dependency information data set; and a priority information data set. These data sets may, in turn, be utilized to represent a configured operational status, a current operational status, or a projected operational status. Package components are discussed in further detail above for FIG. 4. One particular advantage of the present invention is that many different scenarios may be examined. A user, may, for example, desire to test different potential hardware additions to a cluster and investigate how those additions will interact in relation to that cluster. In this example, a user may input the start data set from a selection of desired parameters based on a potential hardware configuration. In other examples, a start data set may be gathered from an existing cluster. That is, in one embodiment, a cluster may be queried to return a current operational status data set. As can be appreciated, a data set may be configured as text file, a managed object file (MOF), or any other configuration well known in the art.

At a step 608, a current status model is created using a placement engine. As noted above, placement is a process by which a package is assigned to a node or in this case, modeled to a node. A current status model is a representation of the start data set received in step 604. As noted above, a current status model may be either represented textually as in Table 1 above or represented graphically as shown in FIG. 3. A current status model represented either textually or graphically must conform to any defined rules and relationships corresponding to a cluster's configuration as, for example, illustrated in FIG. 4. Once a current status model has been created, an event from an event input set (see FIG. 5 (504)) may be applied to the current status model in a step 612. Application of an event is generally a matter of applying a change of status to the current status model and then determining what the resulting changes to the current status model will be. For example, a model having a three-node cluster each running a number of packages may be subjected to an event such as a node failure. The method may then apply the node failure event in accordance with the model's established rules and relationships to shift, for example, processing tasks from the failed node to running node. After an event has been applied to a current status model, results may be stored as a forecast status model at a step 616 whereupon the method determines whether more events may be pending at a step 620.

If the method determines more events are pending, the method returns to a step 612 and continues until no more events are pending. In this manner, a number of events may be applied to a current status model. As can be appreciated, event order is related to temporality since each event is taken in turn. Further iterative steps 612-616, may be conceptually represented by the following equations:
Result (1)=∫(a)
Result (2)=∫(∫(a))
Result (3)=∫(=(∫(a)))
Where (a) is start data and ∫ ( ) is the function that represents a step 616. (3)

In this embodiment, results from the application of an event become start data for a subsequent event until all events have been applied to a given model. An iterative model, as described above, may allow a user to account for temporally sensitive issues. For example, a package having failover properties that may optionally direct the package to more than one node may respond differently depending on which of the nodes fails first. Because relationships and rules may be highly interactive and interdependent, accounting for temporal issues may be difficult or impossible for a user to accomplish manually. Once all events have been processed, a forecast status model data may be output at a step 624. The method then ends.

While this invention has been described in terms of several embodiments, there are alterations, permutations, and equivalents which fall within the scope of this invention. It is therefore intended that the following appended claims be interpreted as including all such alterations, permutations, modifications, and various substitute equivalents as fall within the true spirit and scope of the present invention.

What is claimed is:

1. A method of forecasting a forecast status of a clustered computing system comprising:
creating a current status model of the clustered computing system based on a start data set;
applying an event input set to the current status model; and
creating a forecast status based on the applying the event input set to the current status model.

2. The method of claim 1 wherein the current status model represents a status selected from the group consisting of: a configured operational status, a current operational status, and a projected operational status of the clustered computing system.

3. The method of claim 1 further comprising repeating the steps of applying an event input set and creating a forecast status such that a plurality of event input sets may be tested.

4. The method of claim 1 wherein the start data set comprises:
an application package information data set;
a node information data set;
a dependency information data set; and
a priority information data set.

5. The method of claim 4 wherein the dependency information data set is selected from the group consisting of: a same node exclusion dependency, an all node exclusion dependency, a same node up dependency, an any node up dependency, and a different node up dependency.

6. The method of claim 1 wherein the event input set is selected from the group comprising: a hardware failure, a hardware addition, a node failure, a node addition, an application package failure, a application package addition, a network failure, a package services failure, a shutdown, and a reboot.

7. The method of claim 1 wherein the clustered computing system is configured to be highly available.

8. The method of claim 1 wherein the start data set is configured in managed object format (MOF).

9. A forecasting system for determining a forecast status of a clustered computing system comprising:
an input component configured to provide,
a start data set corresponding to a cluster configuration, the start data set configured to provide a current status model of the clustered computing system, and
an event input set;
a process component configured to apply the event input set to the start data set; and
an output component configured to generate a forecast status of the clustered computing system based on results from the process component.

10. The forecasting system of claim 9 wherein the current status model of the clustered computing system is selected from the group consisting of: a configured operational status, a current operational status, and a projected operational status of the clustered computing system.

11. The forecasting system of claim 10 wherein the clustered computing system configuration model comprises:
an application package information data set;
a node information data set;
a dependency information data set; and
a priority information data set.

12. The forecasting system of claim 11 wherein the dependency information data set is selected from the group consisting of: a same node exclusion dependency, an all node exclusion dependency, a same node up dependency, an any node up dependency, and a different node up dependency.

13. The forecasting system of claim 9 wherein the event input set is selected from the group comprising: a hardware failure, a hardware addition, a node failure, a node addition, an application package failure, a application package addition, a network failure, a package services failure, a shutdown, and a reboot.

14. The forecasting system of claim 9 wherein the clustered computing system is configured to be highly available.

15. The forecasting system of claim 9 wherein the cluster configuration input data set is configured in managed object format (MOF).

16. A computer program product for use in conjunction with a computer system for forecasting a forecast status of a clustered computing system, the computer program product comprising a computer readable storage medium and a computer program mechanism embedded therein, the computer program mechanism comprising:
instructions for creating a current status model of the clustered computing system based on a start data set;
instructions for applying an event input set to the current status model; and
instructions for creating a forecast status model based on the applying the event input set to the current status model.

17. The computer program product of claim 16 wherein the current status model represents a status selected from the group consisting of: a configured operational status, a current operational status, and a projected operational status of the clustered computing system.

18. The computer program product of claim 16 further comprising instructions for repeating the steps of applying an event input set and creating a forecast status such that a plurality of event input sets may be tested.

19. The computer program product of claim 16 wherein the start data set comprises:
an application package information data set;
a node information data set;
a dependency information data set; and
a priority information data set.
